(19) United States
(12) Patent Application Publication
(10) Pub. No.: US 2011/0024198 A1
(43) Pub. Date: Feb. 3, 2011

(54) BEARING SYSTEMS CONTAINING DIAMOND ENHANCED MATERIALS AND DOWNHOLE APPLICATIONS FOR SAME

(75) Inventors: Aaron J. Dick, Houston, TX (US); David A. Curry, Edinburgh (GB); Terry J. Koltermann, The Woodlands, TX (US); Chih Lin, Spring, TX (US); Danny E. Scott, Montgomery, TX (US); Anton F. Zahradnik, Sugarland, TX (US)

Correspondence Address: Traskbritt, P.C. / Baker Hughes, Inc.;Baker Hughes, Inc., P.O. Box 2550, Salt Lake City, UT, 84110, US

(73) Assignee: BAKER HUGHES INCORPORATED, Houston, TX (US)

(21) Appl. No.: 12/901,986

(22) Filed: Oct. 11, 2010

Related U.S. Application Data
(63) Continuation-in-part of application No. 12/367,787, filed on Feb. 9, 2009.
(60) Provisional application No. 61/029,719, filed on Feb. 19, 2008.

(51) Int. Cl. E21B 10/00; F16C 32/00; F04B 39/00

(52) U.S. Cl. 175/371; 384/107; 417/572

(57) ABSTRACT

Downhole tool bearings are provided with diamond enhanced materials. The diamond enhanced materials comprise diamond grains in a matrix of tungsten or silicon carbide or a silicon bonded diamond material. A brazed diamond grit or diamond particles coated with a reactive braze may be utilized for bearing applications. Bearing rings for use in downhole tools may be formed at least in part with the diamond enhanced material. In one embodiment, the bearing rings may be used in a positive displacement motor. In additional embodiments, the bearing rings may be used in a submersible pump.

This application is a continuation-in-part of and claims priority to and the benefit of U.S. patent application Ser. No. 12/367,787 filed on Feb. 9, 2009, which application claims the benefit of U.S. provisional patent application Ser. No. 61/029,719, filed Feb. 19, 2008. The disclosures of each of the foregoing patent applications is incorporated herein in its entirety by reference.

### TECHNICAL FIELD

The present invention relates in general to bearing assemblies and systems for downhole applications and, in particular, to a system and apparatus for bearings for downhole applications containing diamond enhanced materials.

### BACKGROUND

Diamond is a unique bearing material with superior wear resistance compared to traditional bearing materials, such as steel. Downhole tools with diamond enhanced bearings have been investigated in an effort to take advantage of diamond's wear resistant properties. Some diamond bearing systems in rolling cone drill bits and mud motor bearings have been proposed with polycrystalline diamond compacts (PDC), chemical vapor deposition (CVD) diamond, and diamond-like carbon (DLC) coatings. Such PDC bearings are mounted in element arrays over the surfaces of the radial and thrust bearings or in frustoconical shapes. For example, U.S. Pat. No. 4,738,322, entitled Polycrystalline Diamond Bearing System for a Roller Cone Rock Bit to Hall et al. describes the use of PDC rolling cone bit bearings. U.S. Pat. No. 6,068,070, entitled Diamond Enhanced Bearing for Earth-Boring Bit to Scott describes a CVD diamond enhanced bearing for earth boring bits. In addition, U.S. Pat. No. 7,296,641 entitled Rock Drill Bit Having Outer and Inner Rock-Crushing Buttons to Hadin et al.; U.S. patent application Ser. No. 11/594,566 entitled Microwave Sintering to Slutz et al.; U.S. patent application Ser. No. 11/712,067 entitled Composite Abrasive Compact to Tank et al., and U.S. Pat. No. 7,647,992 entitled Polycrystalline Diamond Carbide Composites to Fang et al. describe cutting elements that incorporate diamond enhanced materials.

Although each of these designs is workable, a solution that improves the performance of drill bit bearing systems with other types of material would be desirable. A more cost effective solution that provides the necessary performance advantages would be particularly desirable. Accordingly, there remains a need in the art for cost-efficient bearing systems for earth-boring tools that increase the durability and performance of the bearing systems.

### BRIEF SUMMARY

Embodiments of a system and apparatus for bearings for downhole applications containing diamond enhanced materials are disclosed. The diamond enhanced materials may comprise diamond grains in a matrix of tungsten carbide, silicon carbide, etc. Alternatively diamond grit may be brazed to a steel bearing surface. Diamond particles coated with a reactive braze also may be used. The braze is activated and a layer of brazed diamond particles forms a wear resistant surface that may be applied to a steel bearing surface. These materials may be used for a variety of bearing systems in downhole tools such as rolling cone drill bits, mud motors and pumps.

In some embodiments, bearing rings are formed at least in part with diamond enhanced material, and are installed on at least one of the outer radial bearing surfaces of the journal pin on the rolling cone bit. In other embodiments, the bearing rings are not formed as continuous rings, but as partial or discontinuous rings and attached to the journal pin or cone cavity surfaces. Diamond enhanced material also may be used to form, at least in part, thrust bearings, rollers or balls. In addition, brazed diamond grit may be used to form a diamond enhanced surface on the ball or roller race of the journal pin or cone.

In additional embodiments, the present invention includes a bearing assembly for a downhole tool. The bearing assembly includes at least two opposing, mutually relatively rotatable thrust bearing surfaces. At least a portion of at least one of the at least two opposing, mutually relatively rotatable thrust bearing surfaces comprises a diamond enhanced material.

In additional embodiments, the present invention includes another bearing assembly for a downhole tool. The bearing assembly comprises at least two opposing, mutually relatively rotatable thrust bearing surfaces. At least one of the at least two opposing, mutually relatively rotatable thrust bearing surfaces comprises a silicon bonded diamond material.

In further embodiments, the present invention includes a submersible pump. The submersible pump includes a plurality of stages. Each stage includes a stationary diffuser and a rotatable impeller with a bearing ring set disposed between the diffuser and the impeller. Each bearing of the bearing ring set comprises a silicon bonded diamond material.

In additional embodiments, the present invention includes a motor assembly for use in drilling subterranean formations. The motor assembly comprises a motor configured to apply a torque to a rotary drill bit. The motor is operably coupled to a thrust bearing apparatus. The thrust bearing apparatus comprises a first structure having at least one bearing element defining a first bearing surface. The at least one bearing element of the first structure comprises a silicon bonded diamond material. The thrust bearing apparatus also includes a second structure having at least one bearing element defining a second bearing surface. The first bearing surface and the second bearing surface are configured to engage one another during relative displacement of the first structure and the second structure.

Other features and advantages of the present invention will become apparent to those of ordinary skill in the art through consideration of the ensuing description, the accompanying drawings, and the appended claims.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the description of embodiments of the invention when read in conjunction with the accompanying drawings, in which:

FIG. 1 is a sectional side view of one embodiment of an earth boring drill bit constructed in accordance with the invention;

FIG. 2 is a schematic sectional end view of one embodiment of a rolling cone bearing system constructed in accordance with the invention;

FIG. 3 is a micrograph of one embodiment of a material used for bearing systems and is constructed in accordance with the invention;

FIG. 4 is an enlarged micrograph of the material of FIG. 3 and is constructed in accordance with the invention;

FIG. 5 is a section side view of one embodiment of a bearing assembly including one embodiment of a bearing system of the present invention;

FIG. 6 is an enlarged view of one embodiment of the bearing system of the present invention for use in the mud motor of FIG. 5;

FIG. 7 is a section side view of one embodiment of a submersible pump including one embodiment of a bearing system of the present invention; and

FIG. 8 is an enlarged view of one embodiment of the bearing system of the submersible pump of FIG. 7.

### DETAILED DESCRIPTION

The present invention includes embodiments of a system, method and apparatus for downhole tool bearings containing diamond enhanced materials. The diamond enhanced materials may comprise diamond grains in a matrix of tungsten carbide, silicon carbide, etc. For example, such materials may be provided by the company Element Six (E6) under such commercially available product names as SYNDAX® (i.e., a high temperature, high pressure sintered silicon bonded polycrystalline diamond), or silicon bonded diamond also referred to as ScD (i.e., a low pressure, low concentration diamond enhanced polycrystalline material). The ScD material is produced by a reaction bonding process in which a green body of diamond particles, silicon grit and carbon (produced by the in-situ surface graphitization of the diamond) infiltrated with silicon at sub-atmospheric pressure. The silicon reacts with the carbon to form new silicon carbide which grows epitaxially on the existing silicon carbide grains and diamond particles. Once all the available carbon has reacted, any remaining space is filled by the silicon. Another such material may be aluminum nitride intermetallic-bonded diamond and carbide composite.

In another embodiment, a brazed diamond grit may be utilized for bearing applications. The E6 company provides still another type of diamond enhanced surface that is formed by applying diamond particles coated with a reactive braze. The braze is activated and a layer of brazed diamond particles forms a wear resistant surface that may be applied to a steel bearing surface. These materials may be used for a variety of bearing systems in downhole tools such as rolling cone drill bits, mud motors, pumps and other downhole assemblies used in mineral exploration and production. In addition, these materials may be formed in a bearing system against themselves or against another type of diamond or diamond enhanced wear surface.

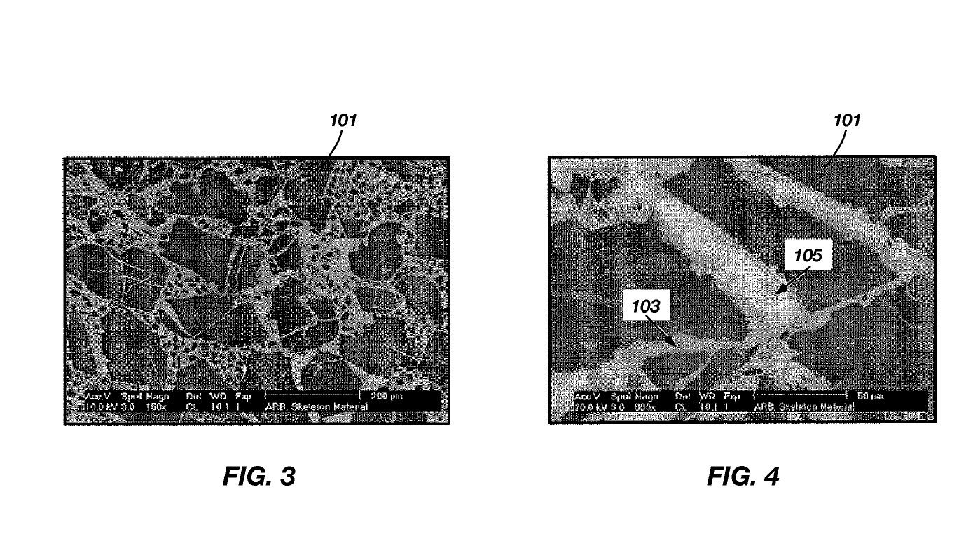

Referring to FIGS. 3 and 4, one embodiment of a material for these applications is depicted in micrographs as a diamond enhanced silicon carbide (SiC) material. By way of example, the diamond 101 may comprise 30% to 70% (by volume), with a grain size of 5 to 250 microns. Finer materials may have a lower diamond content. For example, diamond enhanced tungsten carbide may comprise about 5% to 25% diamond by volume. The diamond may be unsintered, with an open porosity of about 9% in one embodiment. The principle binder phase may comprise βSiC 103 (FIG. 4), and some free Si 105 may be present having 30% to 70% diamond by volume, with a grain size of 5 to 250 microns. In other examples, the material may comprise diamond enhanced WC or diamond film.

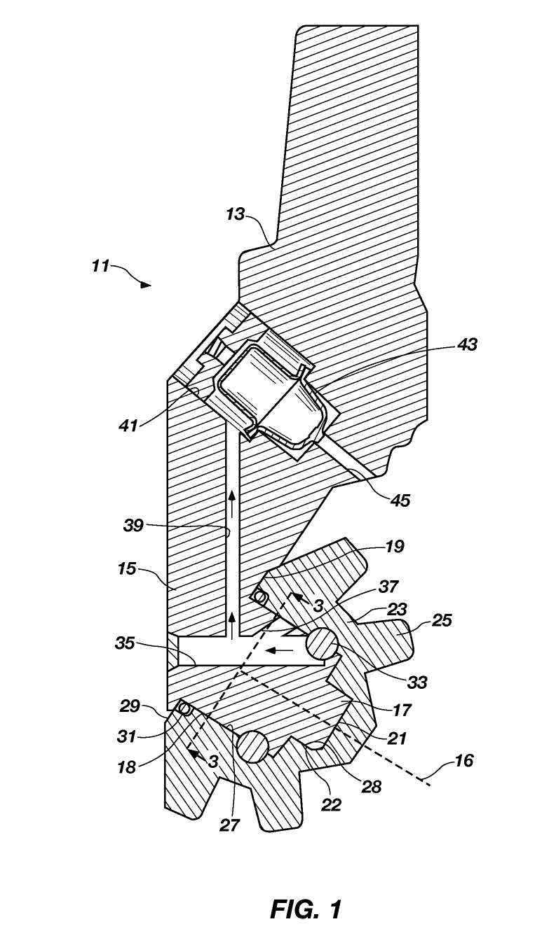

These diamond enhanced materials may be applied to downhole tool bearing systems to take advantage of their wear resistant properties, thus prolonging tool life. An example of a downhole tool containing a bearing system is a rock drill bit, such as the one shown in FIG. 1. In this embodiment, a drill bit 11 has a body 13 at an upper end that is threaded (not shown) for attachment to the lower end of a drill string. Body 13 has at least one bit leg 15, typically three, which extend downward from it. Each bit leg 15 has a bearing pin 17 that extends downward and inward along an axis 16. Bearing pin 17 has an outer end, referred to as last machined surface 19, where it joins bit leg 15. Bearing pin 17 has a main journal surface 18 and a nose 21 having a surface 22 with a smaller diameter than that of surface 18. Surface 22 is generally parallel to surface 18, relative to axis 16.

A cone 23 rotatably mounts on bearing pin 17. Cone 23 has a plurality of protruding teeth 25 or compacts (not shown). Cone 23 has a cavity 27 that is slightly larger in diameter than the outer diameter of bearing pin 17. Cone 23 has a back face 29 that is located adjacent, but not touching, the last machined surface 19. If the bearing type is a sealed, lubricated bearing, a seal 31 is located in a seal cavity adjacent to the back face 29. Seal 31 may be of a variety of types, and in this embodiment is shown to be an elastomeric o-ring. Seal 31 engages a gland or area of bearing pin 17 adjacent to last machined surface 19. Other types of elastomeric seals may be used such as dual seals, seals with non-circular cross-sectional shapes, etc. Mechanical face seals also may be used.

Cone 23 may be retained in more than one manner. In the embodiment shown, cone 23 is retained on bearing pin 17 by a plurality of balls 33 that engage a mating annular recess formed in cone cavity 27 and on bearing pin 17. Balls 33 lock cone 23 to bearing pin 17 and are inserted through a ball passage 35 during assembly after cone 23 is placed on bearing pin 17. Ball passage 35 extends to the exterior of bit leg 15 and may be plugged as shown after balls 33 are installed.

Portions of a cavity 27 slidingly engage journal surfaces 18 and 22. In one embodiment, the outer end of journal surface 18 is considered to be at the junction with the gland area engaged by seal 31, and the inner end of journal surface 18 is considered to be at the junction with the groove or race for balls 33. Journal surfaces 18 and 22 serve as a journal bearing for loads imposed along the axis of bit 11.

In sealed lubricated bearings, a first lubricant port 37 is located on an exterior portion of journal surface 18 of bearing pin 17. In one embodiment, first port 37 is located on the upper or unloaded side of journal surface 18 of bearing pin 17 between balls 33 and seal 31. First port 37 also could be on other areas of journal surface 18. First port 37 is connected to a first passage 39 via ball passage 35. First passage 39 leads to a lubricant reservoir 41 that contains a lubricant.

Lubricant reservoir 41 may be of a variety of types. In one embodiment, an elastomeric diaphragm 43 separates lubricant in lubricant reservoir 41 from a communication port 45 that leads to the exterior of bit body 13. Communication port 45 communicates the hydrostatic pressure on the exterior of bit 11 with pressure compensator 43 to reduce and preferably equalize the pressure differential between the lubricant and the hydrostatic pressure on the exterior.

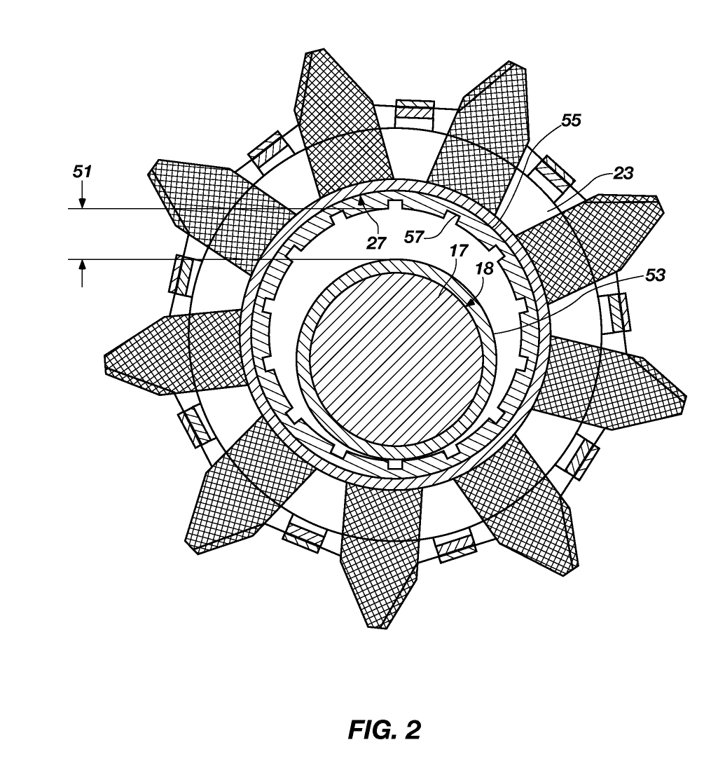

The precise positioning between bearing pin 17 and cone 23 varies as the drill bit 11 is loaded during service, thereby creating eccentricity. The eccentricity is a result of the differences between the outer diameters of journal surfaces 18 and 22 and the inner diameters of cone cavity surfaces 27 and 28. FIG. 2 shows an annular clearance 51 that is greatly exaggerated for illustration purposes. In actuality, annular clearance 51 is quite small, typically being no more than about 0.006 inches on a side. Annular clearance 51 may be the same as in the prior art bits of this type.

Referring again to FIGS. 1 and 2, one embodiment of a diamond enhanced bearing system is shown. In this embodiment, one or more bearing rings 53 is formed at least in part with diamond enhanced material. Bearing ring(s) 53 are installed on either or both of the outer surfaces 18 and 22 of the journal pin 17 on the rolling cone bit. One or more separate rings 55 may be formed at least in part with diamond enhanced material. Ring(s) 55 are installed on either or both of the inner surfaces 27 and 28 of the cone bearing 23. One or more of the bearing rings 53, 55 may be attached to the respective surfaces 18, 22, 27 and 28 of journal pin 17 and cone 23 using bonding technologies such as brazing, soldering, or adhesives. An alternative to bonding attachment methods is to mechanically lock the rings by shrink fitting or other methods.

In other embodiments, the bearing rings are not formed as continuous rings, but as partial or discontinuous rings, or as ring sections (e.g., half-rings), and attached to the journal pin or cone cavity surfaces. These embodiments may include thrust bearings made of diamond enhanced material, rollers and/or roller race surfaces and balls and/or ball race surfaces made of diamond enhanced material. These bearing surfaces also are formed at least in part with diamond enhanced material and may be attached to portions of the journal or cone bearing surfaces.

The schematic drawing in FIG. 2 illustrates that channels 57 may be formed in the cone bearing to allow lubricant to enter the bearing. The bearing may be a lubricated, sealed bearing, or an open bearing with passages to flush drilling fluid through the bearing.

In some embodiments of a downhole tool constructed in accordance with the invention, the tool has a body having a bearing element (e.g., surface, pin, etc.) extending along an axis. The bearing pin has a journal surface and a nose surface with a smaller diameter than that of the journal surface. A rotatable element (e.g., cone) is rotatably mounted to the bearing pin and has a cavity slidingly engaging the journal and nose surfaces. A diamond enhanced bearing system is between the bearing pin and the rotatable element comprising at least one load carrying bearing surface (e.g., ring) formed at least in part with diamond enhanced material.

In other embodiments, the diamond enhanced material may comprise one of: diamond grains in a matrix of tungsten carbide; a high temperature, high pressure sintered silicon bonded polycrystalline diamond; a low pressure, low concentration diamond enhanced polycrystalline material; an aluminum nitride intermetallic bonded diamond and carbide composite; a brazed diamond grit; and diamond particles coated with a reactive braze. The diamond enhanced material may comprise 30% to 70% diamond by volume, with a grain size of 5 to 250 microns. The diamond enhanced material may be unsintered, have an open porosity of about 9%, and a principle binder phase comprising βSiC with some free Si. The diamond may be diamond enhanced WC or diamond film.

In still other embodiments, the bearing ring is installed on at least one of the journal and nose surface of the bearing pin. The bearing ring may comprise a plurality of bearing rings that are formed at least in part with diamond enhanced material. The bearing rings may be installed on both the journal and nose surfaces and on the cavity. The bearing ring may be attached with one of brazing, soldering, adhesives and mechanical locking by shrink fitting, pinning, splining or keyways. Alternatively, the bearing ring is a partial ring and discontinuous, or may be formed in ring sections, with or without channels as illustrated in the drawings. The bearing ring may comprise a thrust bearing made of diamond enhanced material, a roller, a roller race surface, or a ball and a ball race surface made of diamond enhanced material. Moreover, these various embodiments may be used in many different combinations as well.

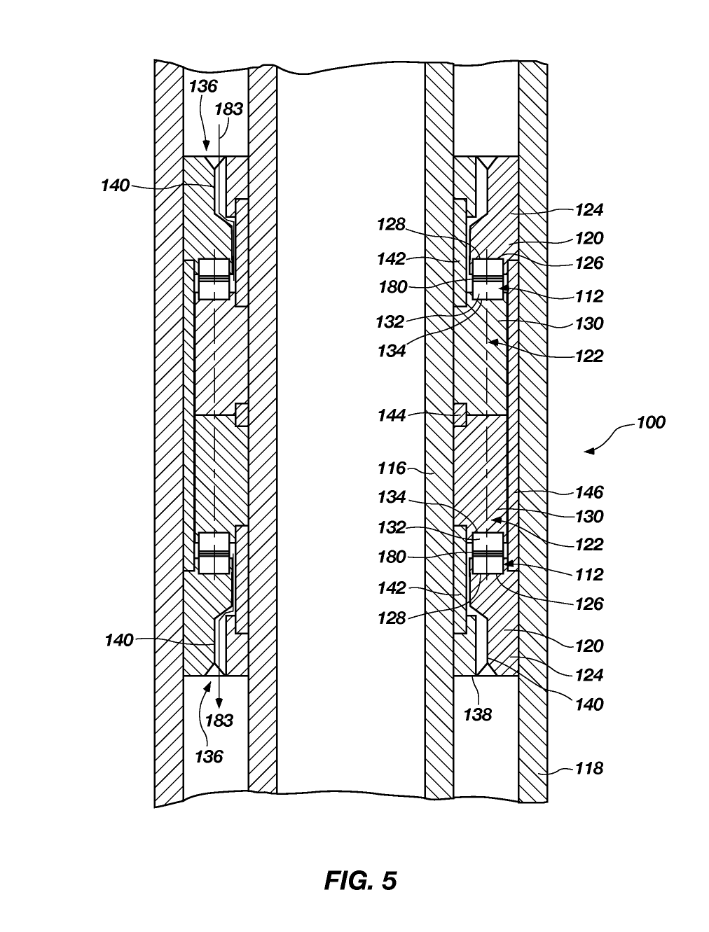

The bearing assemblies including diamond enhanced material as described herein may also be used in additional subterranean tools including, for example, pumps, motors, turbines, and rotary steerable tools. FIG. 5 illustrates the general arrangement of a down hole motor bearing assembly 100 which incorporates two diamond enhanced thrust bearing assemblies 112 of the present invention. While the diamond enhanced thrust bearing assemblies 112 of the present invention may be referred to herein as including one or more bearing rings, it is understood that the thrust bearing assemblies 112 may include any two mutually relatively rotatable bearing surfaces having a desired size and shape. Such motor bearing assemblies 100 may be included as a portion of a positive displacement motor commonly referred to as a mud motor as is known in the art, and, therefore, not described herein. Such mud motors are described in detail in, for example, U.S. Pat. No. 6,543,132 entitled “Methods of Making Mud Motors,” which issued on Apr. 8, 2003, the entire disclosure of which is incorporated herein by this reference.

As shown in FIG. 5, the bearing assembly 100 includes a central tubular down-hole motor driveshaft 116 located rotatably within a tubular bearing housing 118, with the downhole motor bearing assembly 100 located and providing for relative rotation between the driveshaft 116 and the housing 118. Components above and below the actual bearing assembly 100 are not illustrated. Those skilled in the art will nevertheless recognize that the driveshaft 116 is rotated by the action of the downhole motor and supplies rotary drive to a drill bit, such as the drill bit 11 illustrated in FIG. 1. The driveshaft 116 rotates relative to housing 118 during motor operation.

The diamond enhanced thrust bearing assemblies 112 include a pair of first bearing rings 120 and a pair of second bearing rings 122. Each of the first bearing rings 120 and the second bearing rings 122 comprises the silicon bonded diamond material as previously described. In some embodiments, each first bearing ring 120 may include a support element 124, formed of, for example sintered tungsten carbide, and the silicon bonded diamond material 126 formed on the support element 124. Similarly, each second bearing ring 122 may include a support element 130 formed of, for example, sintered tungsten carbide having the silicon bonded diamond material 132 formed thereon. Alternatively, in some embodiments, the each of the first bearing rings 120 and the second bearing rings 122 may be formed entirely of the silicon bonded diamond material.

The assembly 100 also includes two radial bearing assemblies 136. Each of these assemblies includes a rotating radial bearing ring 138 which runs, at a bearing interface 140, against a portion of the support element 124 of the first bearing ring 120. The assembly 100 also includes radial inner spacer rings 142, 144 and a radially outer spacer ring 146. In practice, an axial compressive force is applied by external locknuts (not illustrated) to the radially outer components of the assembly 100, i.e., to the first bearing rings 120 and the spacer ring 146. The compressive force locks the first bearing rings 120 and the spacer ring 146 frictionally to one another and to the bearing housing 118. Similarly, locknuts apply an axial compressive force to the radially inner components of the assembly 100, i.e., to the radial bearing rings 138, spacer rings 142, second bearing rings 122, and spacer ring 144. The applied compressive force locks the radial bearing rings 128, spacer rings 142, second bearing rings 122 and spacer ring 144 to one another and to the driveshaft 116, so that when the driveshaft is rotated by the action of the motor, these components rotate with it.

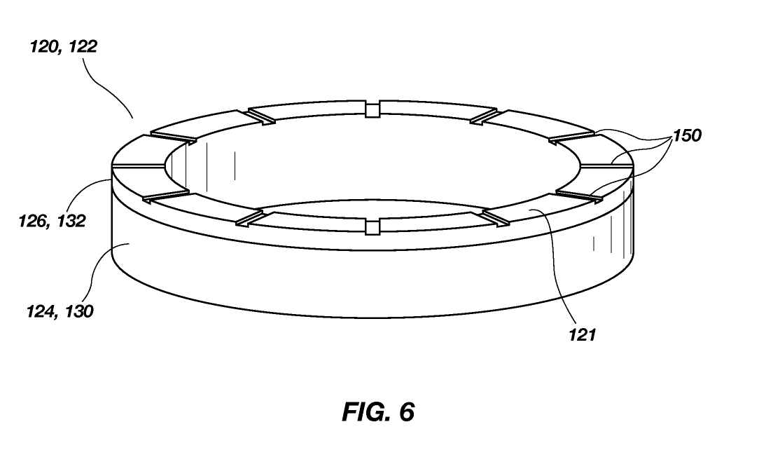

FIG. 6 is an enlarged illustration of the first bearing ring 120 and the second bearing ring 122. As shown, the bearing ring 120, 122 includes the silicon bonded diamond material 126, 132 formed on a surface of the support element 124, 130. The silicon bonded diamond material 126, 132 may comprise the diamond enhanced silicon carbide (SiC) material described above with respect to FIGS. 3 and 4. At least one recess having a desired shape, such as a dimple or a groove 150 may be formed in the silicon bonded material 126, 132. For example, as shown in FIG. 6, a plurality of equidistant radially extending grooves 150 may be formed in the silicon bonded diamond material 126, 132. The silicon bonded diamond material 126, 132 may be attached to the support element 124, 130 using known attachment techniques including, for example, brazing, soldering, adhesives and mechanical locking by shrink fitting, pinning, splining or keyways. As previously discussed, in some embodiments, the support element 124, 130 may also be formed of the silicon bonded diamond material. The silicon bonded diamond material 126, 132 may have a thickness of about ten millimeters (10 mm) to about five hundred millimeters (500 mm). The bearing surface 121 of the silicon bonded diamond material 126, 132 may be at least substantially planar.

While the bearing rings 120, 122 are described as including a silicon bonded diamond material, other diamond enhanced materials may also be used to form the bearing rings 120, 122. For example, in additional embodiments, the diamond enhanced material may comprise one of: diamond grains in a matrix of tungsten carbide; a high temperature, high pressure sintered silicon bonded polycrystalline diamond; a low pressure, low concentration diamond enhanced polycrystalline material; an aluminum nitride intermetallic bonded diamond and carbide composite; a brazed diamond grit; and diamond particles coated with a reactive braze. The diamond enhanced material may comprise 30% to 70% diamond by volume, with a grain size of 5 to 250 microns. The diamond enhanced material may be unsintered, have an open porosity of about 9%, and a principle binder phase comprising βSiC with some free Si. The diamond may be diamond enhanced WC or diamond film.

Referring again to FIG. 5, in operation of the diamond enhanced thrust bearing assemblies 112, the silicon bonded diamond material 126 of the first bearing ring 120 and the silicon bonded diamond material 132 of the second bearing ring 122 run against one another at bearing interfaces 180, taking the axial thrust applied to the shaft 116. The silicon bonded diamond material 126 of the first bearing ring 120 and the silicon bonded diamond material 132 of the second bearing ring 122 exhibit a very low coefficient of friction yet are extremely hard, enabling them to take a large axial loading without undue damage. For example, the silicon bonded diamond material 126, 132 with water has a coefficient of sliding friction of about 0.1. Comparatively, unlubricated tungsten carbide and unlubricated steel have a coefficient of sliding friction of about 0.2.

The bearing interfaces 180 may be cooled and lubricated during operation by drilling fluid or mud which is exhausted from the downhole motor and which flows axially down the assembly and radially through the grooves 150 (FIG. 6) between the silicon bonded diamond materials 126, 132 in the bearing rings 120, 122. A typical drilling fluid path is depicted in FIG. 5 with numeral 183.

In additional embodiments, the first bearing ring 120 and second bearing ring 122 may not be formed as continuous rings, but as partial or discontinuous rings, or as ring sections (e.g., half-rings). These embodiments may include bearings, rollers and/or roller race surfaces and balls and/or ball race surfaces including at least one bearing surface formed of the silicon bonded diamond material.

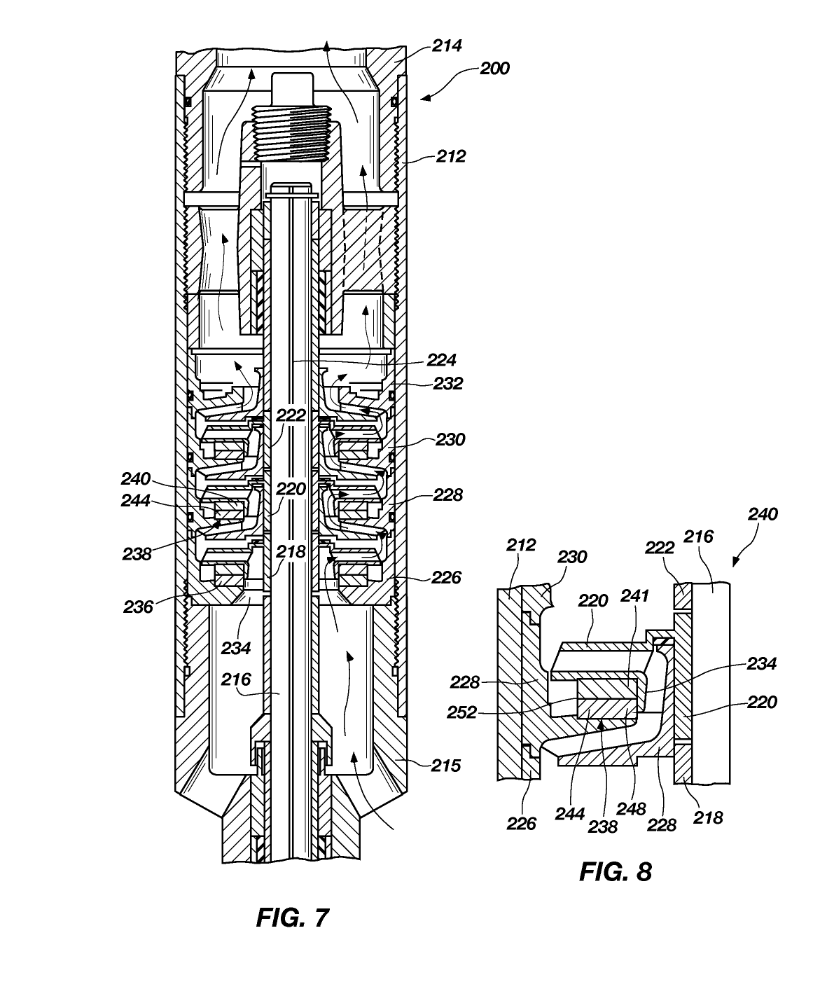

The bearing rings 120, 122 of the present invention as illustrated in FIG. 6 may be used in any downhole tool in which bearing rings 120, 120 are utilized including pumps, motors, and drill bits. For example, the bearing rings 120, 122 may be included in a turbine downhole motor, as known in the art, and described in, for example, U.S. Pat. No. 5,112,188 entitled Multiple Stage Drag and Dynamic Turbine Downhole Motor which issued May 12, 1992, the entire disclosure of which is incorporated herein by this reference. In an additional example, the bearing rings 120, 122 may be included in a centrifugal pump 200, as illustrated in FIG. 7. The pump 200 includes a hollow housing 212 that is connected at its upper end with an adaptor 214. The lower end of the housing 212 is connected through an adaptor 215 to a device known as a sealing chamber (not shown) which has its lower end connected to a submersible electric motor (not shown) for driving the pump 200. A pump shaft 216 which is rotated by the motor extends upwardly into the pump 200.

The shaft 216 is connected for rotation with impellers 218, 220, 222 by means of a key 224. The pump also includes diffusers 226, 228, 230, and 232. The diffusers 226, 228, 230, 232 include a centrally located annular opening 34 providing for a flow of fluid into the impeller 218, 220, 222. To provide for the smooth rotation of the impellers 218, 220, 222 relative to the diffusers 226, 228, and 230, bearing assemblies 236, 238, 240 for carrying both thrust and radial loads are located between a respective impeller and diffuser.

FIG. 8 is an enlarged view of one of the bearing assembly 240 of FIG. 7. As shown in FIG. 8, the bearing assembly 240 includes a first bearing ring 241 and a second bearing ring 244. The first bearing ring 241 and the second bearing ring 244 may be substantially similar to the bearing ring 120, 122 described above in FIG. 6. As previously described regarding FIG. 6, each of the first bearing ring 241 and the second bearing ring 244 may include a support element 124, 130 having a silicon bonded diamond material 126, 132 formed thereon. The first bearing ring 241 may be bonded to the impeller 220 and the second bearing ring 244 may be bonded to the diffuser 228.

In operation of the pump 200, the motor causes the shaft 216 to rotate which causes the impellers 218, 220, 222 to rotate and which causes fluid to pass through the pump 200 as illustrated by the arrows in FIG. 7. As the impellers 218, 220, 222 the first bearing ring 241 and the second bearing ring 244 of each of the bearing assemblies 236, 238, 240 run against one another at a bearing interface 252. The silicon bonded diamond material 126 of the first bearing ring 241 and the silicon bonded diamond material 132 of the second bearing ring 244 exhibit a very low coefficient of friction yet are extremely hard, enabling them to take a large axial loading without undue damage.

While the present invention has been described herein with respect to certain embodiments, those of ordinary skill in the art will recognize and appreciate that it is not so limited. Rather, many additions, deletions and modifications to the embodiments described herein may be made without departing from the scope of the invention as hereinafter claimed, including legal equivalents. In addition, features from one embodiment may be combined with features of another embodiment while still being encompassed within the scope of the invention as contemplated by the inventors.

What is claimed is:

1. A bearing assembly for a downhole tool, the assembly comprising:
at least two opposing, mutually relatively rotatable bearing surfaces, at least a portion of at least one of the at least two opposing, mutually relatively rotatable bearing surfaces comprising a diamond enhanced material.

2. The bearing assembly of claim 1, wherein the diamond enhanced material comprises one of:
diamond grains in a matrix of tungsten carbide;
a high temperature, high pressure sintered silicon bonded polycrystalline material;
a high temperature, low pressure sintered diamond;
a high temperature, low pressure sintered silicon bonded polycrystalline material;
a silicon bonded carbide material;
an aluminum nitride intermetallic bonded diamond and carbide composite;
a brazed diamond grit; and
diamond particles coated with a reactive braze.

3. The bearing assembly of claim 1, wherein the diamond enhanced material comprises about 30% to about 70% diamond by volume.

4. The bearing assembly of claim 3, wherein the diamond enhanced material has a coefficient of sliding friction of about 0.1.

5. The bearing assembly of claim 1, further comprising a plurality of recesses formed in the diamond enhanced material.

6. The bearing assembly of claim 5, wherein each recess of the plurality of recesses comprises at least one of a groove and a dimple.

7. The bearing assembly of claim 1, wherein the bearing surfaces are substantially planar.

8. A bearing assembly for a downhole tool, the assembly comprising:
at least two opposing, mutually relatively rotatable bearing surfaces, at least one of the at least two opposing, mutually relatively rotatable bearing surfaces comprising a silicon bonded diamond material.

9. The bearing assembly of claim 8, wherein the at least two opposing, relatively rotating bearing surfaces have a coefficient of friction of about 0.1.

10. The bearing assembly of claim 8, wherein the silicon bonded diamond material comprises about 30% to about 70% diamond by volume.

11. The bearing assembly of claim 8, wherein each bearing surface comprises a plurality of recesses in at least one of the at least two opposing, mutually relatively rotatable bearing surfaces.

12. The bearing assembly of claim 8, wherein the silicon bonded diamond material is formed over a supporting element.

13. The bearing assembly of claim 13, wherein the supporting element comprises tungsten carbide.

14. The bearing assembly of claim 13, wherein the silicon bonded diamond material is attached to the supporting element with one of brazing, soldering, adhesives, and mechanical locking by shrink fitting, pinning, splining or keyways.

15. A submersible pump comprising:
a plurality of stages, each stage including a stationary diffuser and a rotatable impeller with a bearing set disposed between the diffuser and the impeller, the bearing set comprising at least two opposing, mutually relatively rotatable bearing surfaces, at least one of the at least two opposing, mutually relatively rotatable bearing surfaces comprising a silicon bonded diamond material.

16. The submersible pump of claim 15, wherein at least one of the at least two opposing, mutually relatively rotatable bearing surfaces comprising a silicon bonded diamond material comprises a plurality of recesses in the silicon bonded diamond material configured to allow a fluid to lubricate and cool the at least two opposing, mutually relatively rotatable bearing surfaces.

17. The submersible pump of claim 15, wherein a first bearing of the bearing set is attached to the diffuser and a second bearing of the bearing set is attached to the impeller.

18. The submersible pump of claim 15, wherein the at least two opposing, mutually relatively rotatable bearing surfaces comprise at least one of a thrust bearing and a radial bearing.

19. A motor assembly for use in drilling subterranean formations, the motor assembly comprising:
a motor configured to apply a torque to a rotary drill bit, the motor operably coupled to a bearing apparatus; wherein the bearing apparatus comprises:
a first structure having at least one bearing element defining a first bearing surface, the at least one bearing element of the first structure comprising a silicon bonded diamond material; and
a second structure having at least one bearing element defining a second bearing surface, the first bearing surface and the second bearing surface configured to engage one another during relative displacement of the first structure and the second structure.

20. The motor assembly of claim 19, wherein the bearing apparatus comprises at least one of a radial bearing apparatus and a thrust bearing apparatus.
